(19) United States
(12) Patent Application Publication
(10) Pub. No.: US 2026/0094229 A1
(43) Pub. Date: Apr. 2, 2026

(54) METHOD AND SYSTEM TO IMPLEMENT USAGE OF REMOTE GPUS

(71) Applicant: Cloudexe Inc., Cupertino, CA (US)

(72) Inventor: Makarand Dharmapurikar, Saratoga, CA (US)

(73) Assignee: Cloudexe Inc., Cupertino, CA (US)

(21) Appl. No.: 19/342,388

(22) Filed: Sep. 26, 2025

Related U.S. Application Data
(60) Provisional application No. 63/700,535, filed on Sep. 27, 2024.

(51) Int. Cl. G06T 1/20; G06T 1/60

(52) U.S. Cl. CPC G06T 1/20; G06T 1/60

(57) ABSTRACT

Disclosed is an improved approach to provide usage of remote GPUs. The approach provides systems and methods for executing software workloads on remote servers while preserving the appearance of local execution at a client machine. A client-side resource shim and secure network tunnel proxy interactions with operating system resources, enabling workloads to access files, networks, and GPUs on the remote server transparently. The system employs caching, mutable software environments, and replacement maps to maintain compatibility across heterogeneous hardware and optimize performance. Intelligent matchmaking and telemetry-based resource selection allow workloads to dynamically utilize appropriate remote GPUs, including across cloud providers or edge networks. The invention enables GPU arbitrage, workload porting, efficient infrastructure utilization, and transparent acceleration for edge devices without modifying the original software.

### RELATED APPLICATION

The present application claims the benefit of priority to U.S. Provisional Patent Application Ser. No. 63/700,535 titled “METHOD AND SYSTEM TO IMPLEMENT USAGE OF REMOTE GPUS” filed on Sep. 27, 2024, which is hereby incorporated by reference in its entirety.

### BACKGROUND

In conventional system designs, the environment of the system is tightly coupled with the hardware server on which it runs. What this means is that a workload that runs on that system is typically limited to using only the resources that exist on that system. With conventional systems, it is effectively impossible to separate the hardware execution environment from the software environment.

To explain, consider if an executable container is executing a workload that requires a graphical processor unit (GPU). Conventionally, only the GPU(s) that exist on that system would be used by that container to run the workload. However, this strict limitation to use only the GPUs on the local system is problematic or inefficient if, for example, the local GPU is currently overloaded or if the characteristics of the workload would really require a different GPU than the one on that system for efficient or effective performance.

Therefore, there is a need for a solution to address these limits of conventional systems.

### SUMMARY

Some embodiments provide an improved approach to implement usage of remote GPUs.

The invention generally provides an approach for creating a highly portable and adaptable system for running workloads. It goes beyond simple virtualization or containerization by adding a layer of intelligence that dynamically adjusts the software environment and matches workloads to the most suitable hardware. It is a system designed for maximum flexibility and efficiency, allowing software to run seamlessly on a wide variety of hardware configurations.

Further details of aspects, objects, and advantages of the invention are described below in the detailed description, drawings, and claims. Both the foregoing general description and the following detailed description are exemplary and explanatory, and are not intended to be limiting as to the scope of the invention.

### BRIEF DESCRIPTION OF THE FIGURES

The drawings illustrate the design and utility of some embodiments of the present invention. It should be noted that the figures are not drawn to scale and that elements of similar structures or functions are represented by like reference numerals throughout the figures. In order to better appreciate how to obtain the above-recited and other advantages and objects of various embodiments of the invention, a more detailed description of the present inventions briefly described above will be rendered by reference to specific embodiments thereof, which are illustrated in the accompanying drawings. Understanding that these drawings depict only typical embodiments of the invention and are not therefore to be considered limiting of its scope, the invention will be described and explained with additional specificity and detail through the use of the accompanying drawings.

FIG. 1A illustrates coupling problems with conventional systems designs.

FIG. 1B shows tight coupling between layers.

FIG. 2A shows how to decouple hardware from the OS and Application and Orchestration layers.

FIG. 2B shows a high-level flowchart of operations that are performed to implement some embodiments of the invention.

FIG. 2C shows a detailed flowchart of actions that are performed.

FIG. 3 shows a flowchart of an approach to implement caching according to some embodiments.

FIG. 4A shows a flowchart of an approach to maintain replacement maps.

FIGS. 4B-1 to 4B-5 provide an illustrative example sequence of this processing.

FIG. 5 shows a flowchart of an approach to implement user-privacy aware caching according to some embodiments of the invention.

FIG. 6 shows a flowchart of an approach to implement tunnelling according to some embodiments of the invention.

FIG. 7 shows a flowchart of an approach to implement mutable environments.

FIG. 8 shows the distributed system architecture.

FIG. 9 illustrates matchmaking logic according to some embodiments.

FIGS. 10 and 11 are block diagram of an illustrative computing system suitable for implementing an embodiment of the present invention.

### DETAILED DESCRIPTION OF THE EMBODIMENTS OF THE INVENTION

Various embodiments are described hereinafter with reference to the figures. It should be noted that the figures are not necessarily drawn to scale. It should also be noted that the figures are only intended to facilitate the description of the embodiments, and are not intended as an exhaustive description of the invention or as a limitation on the scope of the invention. In addition, an illustrated embodiment need not have all the aspects or advantages shown. An aspect or an advantage described in conjunction with a particular embodiment is not necessarily limited to that embodiment and can be practiced in any other embodiments even if not so illustrated. Also, reference throughout this specification to “some embodiments” or “other embodiments” means that a particular feature, structure, material, or characteristic described in connection with the embodiments is included in at least one embodiment. Thus, the appearances of the phrase “in some embodiments” or “in other embodiments,” in various places throughout this specification are not necessarily referring to the same embodiment or embodiments.

With regards to software environments, computing workloads exist in an environment surrounding the workload, that makes the workload function, and usable. Some environments include some or all of: (1) Program code (what is considered as the “software” itself); (2) Data needed to operate the program (configuration, database, etc . . . ); (3) Language runtimes (Java, Python, etc.); (4) Frameworks (like PyTorch, Tensorflow); (5) Libraries (like NVIDIA CUDA, Intel OneAPI, . . . ); (6) APIs used by the code (such as Azure, AWS APIs); (7) Orchestration mechanism, that manages lifecycle of the workload (Like Kubernetes); (8) OS (Like Linux).

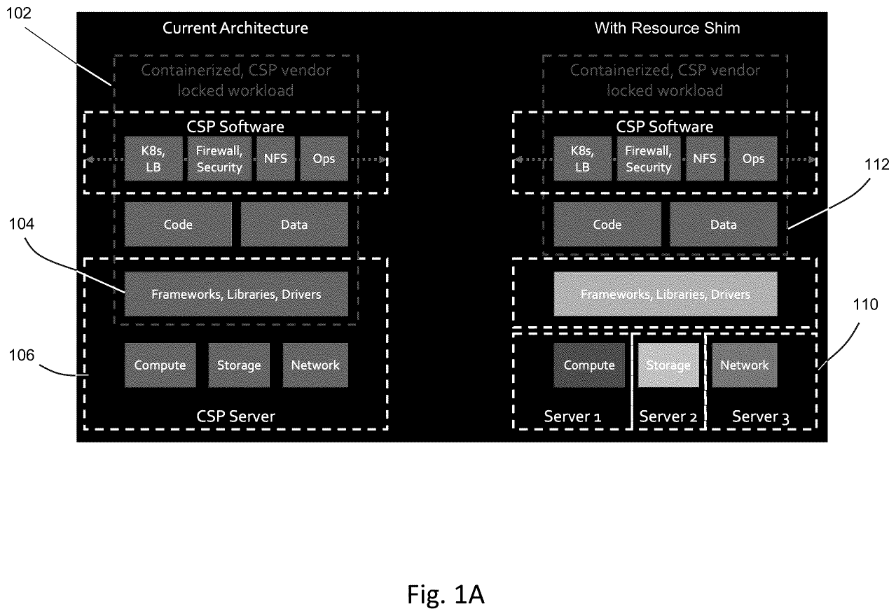

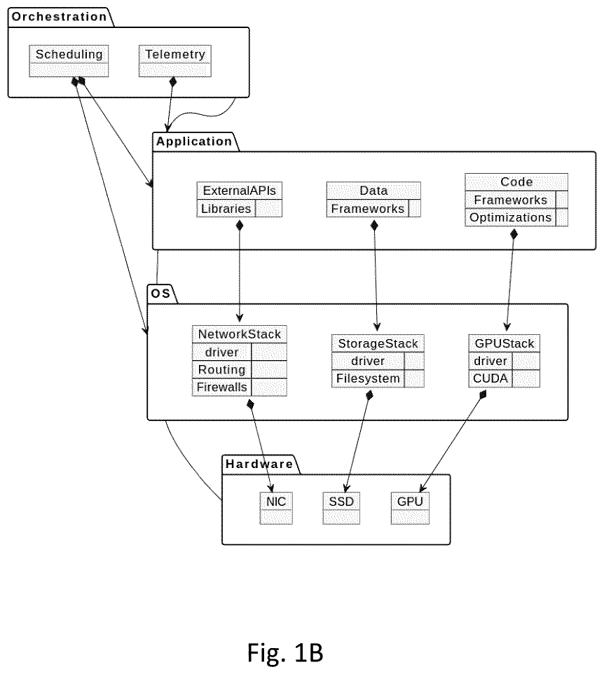

As shown on the left side of FIG. 1A, a conventional system design may correspond to coupling problems. This is because the environment for running a containerized workload 102 is tightly coupled with the hardware server 106 on which it runs. There are many reasons for this. First, the OS (operating system) is tightly tied to the specific hardware (e.g., motherboard, CPU architecture, GPU (graphics processing unit) architecture, hard drives, memory, network) that is provided by a cloud service provider (CSP). In addition, the libraries, frameworks, and languages (104) are tied to the OS. There are OS-specific versions and limitations on each of these. Furthermore, the program code is tightly tied to the libraries, frameworks and language and external APIs (application programming interfaces). In the current example, this means that a containerized workload in a conventional system is therefore very tightly coupled to the framework, libraries, and drivers on that local system. This makes it effectively impossible to separate the hardware execution environment from the software environment.

The illustrated example of FIG. 1A is in the context of a containerized application. The container-based approach to software implementation involves packaging an application and all its dependencies into a single, isolated unit called a container. Unlike traditional virtual machines, which virtualize the entire hardware stack, containers are lightweight, using the host machine's operating system kernel while providing their own isolated file system and resources. This approach offers significant benefits, including enhanced portability and consistency, as the application and its environment are bundled together. Tools like Docker are used to build and manage these containers, while orchestrators like Kubernetes automate their deployment, scaling, and management in production. It is noted that the container-based approach described herein is described for purposes of illustration only, and not by way of limitation unless expressly claimed as such. Therefore, while the inventive concepts disclosed herein are applicable to containerized applications, they are also applicable to other application implementations as well, such as virtual machines and non-container applications.

FIG. 1B shows the tight coupling between multiple system layers (e.g., Hardware, OS, Application, Orchestration). OS facilities like Routing, Firewall, Filesystem, CUDA (compute unified device architecture) depend directly upon the driver. Drivers and firmware depend upon the specific hardware (NIC, SSD, GPU, etc.). Application building blocks like External APIs, Datasets, and code depend upon Frameworks. Frameworks (and libraries) directly depend upon the OS facilities. In particular, in AI domain, framework like PyTorch and Tensorflow have direct knowledge of underlying hardware. Orchestration layers like Kubernetes depend upon both OS facilities and the application. These dependencies make for a tight coupling that typically makes it impossible to run an application on a different hardware.

Embodiments of the invention provide an improved approach to implement system designs, where the workload can be decoupled from those underlying system elements. The right-hand side of FIG. 1A illustrates the advancement of embodiments of the current invention.

Firstly, there is separation of the hardware 110 from a software environment 112. The workload's environment can stay the same, but the workload execution can happen on a different physical hardware server. In addition, a mutable software environment is provided. This allows changes to the software environment, to make it suitable to run on a different hardware environment for which it was originally not designed to run. This is achieved in some embodiments by remote mounting the subsystems upon which the software environment relies.

In further embodiments, intelligent/smart orchestration may also be provided. The software stack of some embodiments collects telemetry from workload execution and underlying hardware, and uses it to select an appropriate hardware server for execution the workload, e.g., by matching a workload to a specific hardware server. The mutability of the software environment may be applied to adapt workloads for execution to make the hardware compatible with the workload.

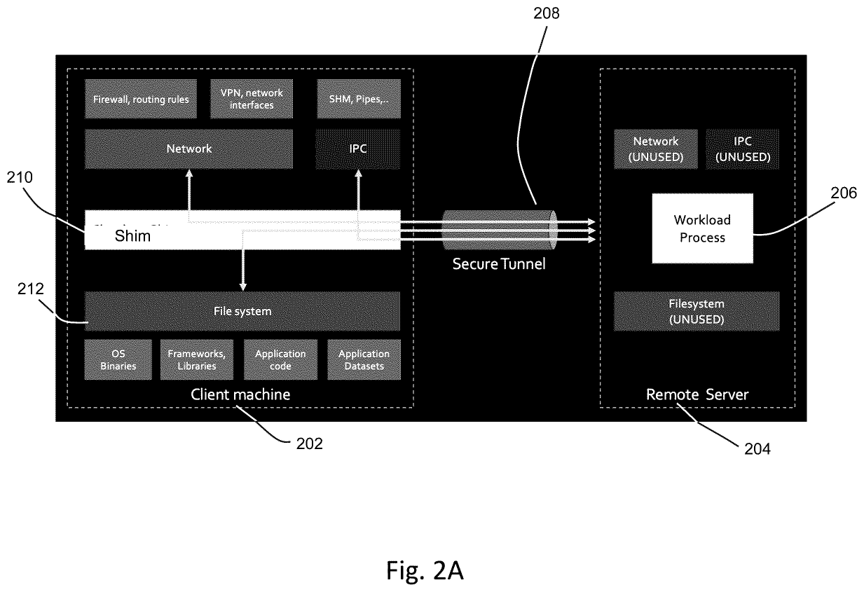

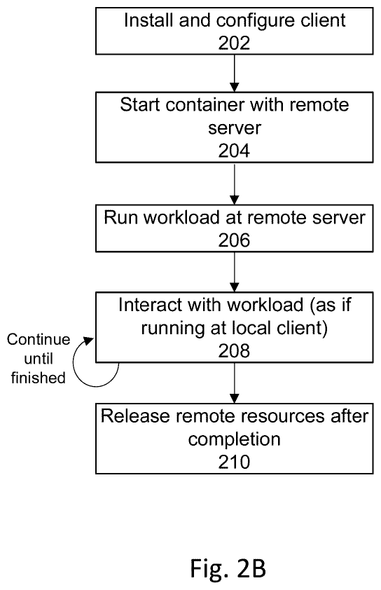

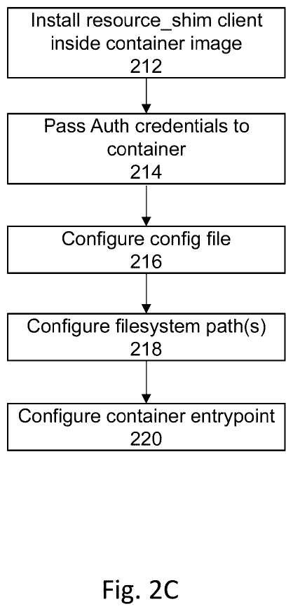

FIG. 2A shows how to decouple the hardware from the OS, application, and orchestration layers according to some embodiments of the invention. On the left side of FIG. 2A, a client machine 202 is shown, representing the system originally designated to execute the workload. On the right side, a remote server 204 is depicted, which is the system on which the workload 206 actually executes. Although the workload 206 executes on the remote server 204, the arrangement maintains the external appearance that the workload is executing on the client machine 202. The workloads 206 may include several inter-related and inter-communicating processes, using multiple mechanisms for inter-process communications (IPC) mechanisms, such as pipes, semaphores, shared memory etc. In a conventional environment, these IPC channels would operate exclusively within a single machine. However, in the embodiment of FIG. 2A, the IPC is transparently extended across machines by way of a secure tunnel 208.

In between the two machines is the secure Tunnel 208. The tunnel 208 implements the IPC communication between two processes (one on the client machine 202, one on the server machine 204) using the secure network channel. The secure tunnel 208 therefore provides a logical extension of IPC, filesystem, and networking channels from the client machine 202 to the remote server 204. In some embodiments, the secure tunnel 208 may employ a cryptographic protocol to ensure confidentiality and integrity of communications. The secure tunnel 208 may also support multiplexing of multiple concurrent channels, allowing simultaneous communication for filesystem requests, IPC signaling, and network routing. From the perspective of the workload 206, the communication paths appear as if they originate and terminate locally on the client machine 202, even though they traverse the secure tunnel 208 to reach the remote server 204.The workload 206 behaves as if all processes are running on the client machine.

The client machine has OS facilities like Filesystem, Network, IPC. The system is the mechanism through which OS Binaries, Frameworks, Libraries, Application code, Application Datasets are consumed by the workload. The network is the mechanism through which Firewall, routing rules, VPN, etc. are consumed by the workload. IPC is the mechanism through which SHM (shared memory), Pipes etc. are consumed by the workload.

The Shim 210 (also referred to as Resource_Shim or Resource_Shim Frontend/FE) is the application that facilitates the use of OS facilities on the remote server over the secure tunnel 208. The shim component 210 receives requests from the workload 206 (transmitted over the secure tunnel 208), processes such requests, and responds as if the workload were executing locally. For example, a filesystem read request initiated by the workload 206 on the remote server 204 may be transmitted over the tunnel 208, executed on the filesystem of the client machine 202 by the shim component 210, and returned to the workload 206 without the workload being aware of the redirection.

The filesystem 212 encompasses OS, libraries, frameworks, language runtimes, and local data. When the filesystem follows the workload, it will function the same no matter what physical hardware on which it is running. In some embodiments, the filesystem 212 is logically remotely mounted by the remote server 204 so that the workload 206 may access it directly. This arrangement allows the workload 206 to operate in a consistent environment, regardless of the physical hardware executing the workload. In alternative embodiments, selected portions of the filesystem 212 may be replicated or cached at the remote server 204 to improve performance, while still maintaining synchronization through the secure tunnel 208.

In some embodiments., the inventive concepts of the system operate by remote mounting the filesystem from the client machine (where the workload is supposed to be running originally) on the server machine (where the workload is running). The workload process is essentially moved from the client machine to run on the remote server. The shim component is placed at the client machine as a proxy for the workload that remains at the original client machine. In operation, by moving the workload process to an appropriately selected remote server, this approach therefore allows the workload process to then start using the resources (e.g., GPU) at the remote server, since the workload process is now local to the resources at the remote server. To the rest of the world, it still appears that the workload is still running at the client machine, due to the presence of the shim component at the client machine. In fact, to the extent that the workload process at the remote server still needs to access content at the client machine (e.g., files in the filesystem at the client machine), this can be done by sending request for those files through a secure tunnel to the shim component. It is noted that an implementation of a network filesystem mount can be used that is secure and performant.

The approach of FIG. 2A therefore allows a separation of the workload's logical execution environment that is preserved by leveraging the client machine's OS facilities and filesystem, while the actual computation is performed on the hardware resources of the remote server 204. This decoupling permits flexible assignment of workloads to heterogeneous hardware, allows workloads to utilize specialized resources (e.g., GPUs, TPUs, high-bandwidth memory) on remote servers, and maintains backward compatibility with existing software environments.

Although FIG. 2A depicts a one-to-one arrangement between a client machine 202 and a remote server 204, in alternative embodiments multiple client machines may connect to a single remote server, or a single client machine may redirect workloads across multiple servers. Similarly, the secure tunnel 208 may be implemented over different network topologies (e.g., LAN, WAN, cloud fabric) and may employ different tunneling protocols (e.g., SSH, QUIC, VPN-based tunnels) without departing from the inventive concepts disclosed herein.

FIG. 2B shows a high-level flowchart of operations that are performed to implement some embodiments of the invention. This approach describes a system for remotely executing a workload while making it appear to be running locally. The core problem it solves is the tight coupling of software to specific hardware. This is achieved through a multi-step process.

At 202, the client component is installed and configured. This action sets up the container at the client to be able to perform the inventive operations. The client-side component, typically a container, is installed and configured on the user's local machine. When the user starts the workload, a special shim component intercepts the command. Instead of running the workload locally, the shim transparently moves it to a remote server, which is better suited for the task, for example, by having a powerful GPU.

At 204, the container at the client is started in a manner that activates the inventive operations. For example, the container entry point may be configured to first invoke the shim component. Upon workload launch, the shim redirects execution to a selected remote server. Server selection may be based on preconfigured rules, resource availability, telemetry feedback, or orchestration logic, thereby ensuring that the workload is assigned to a server with suitable resources (e.g., a GPU-enabled server).

At 206, the workload is run at the remote server. From the perspective of the remote server, the workload runs natively and may directly access local hardware resources, including accelerators, storage, and networking. From the perspective of the client machine, however, the shim maintains a proxy presence such that external systems and users perceive the workload as still running locally.

At 208, interactions occur with the workload. The workload then runs on this remote server, but all or many of its interactions—like file system access and network calls—are funneled back to the client machine through a secure tunnel. This gives the illusion that the workload is still running locally. Therefore, based upon operation of the shim component, the interactions proceed as if the workload is running on the client machine, even though it is actually running at the remote server. The secure tunnel provides confidentiality and integrity of these communications. In effect, the workload operates as if it were executing on the client machine, while transparently leveraging the resources of the remote server. Notably, the workload may be using a GPU at the remote server that has been allocated for use to the workload. This continues until the workload completes its needed operations.

At 210, the remote resources (e.g., GPU resources) would be released after completion of the workload. This makes them available for other users, and the entire process is seamless to the user. The resource release may be automatically managed by the orchestration layer or by a resource manager executing on the server.

This innovative approach therefore offers a flexible way to leverage powerful hardware without being tied to a specific local machine. The system provides a transparent mechanism to decouple workload execution from the client hardware environment. The approach allows workloads to take advantage of remote, high-performance hardware without requiring modification to the workload itself or to its associated software stack.

While this figure illustrates a single flow from installation to resource release, in alternative embodiments additional operations may be incorporated. For example, resource allocation policies may be dynamically adjusted based on real-time telemetry, failover may be provided to migrate an executing workload between remote servers, or multiple workloads may be multiplexed across a shared remote server. Such variations remain within the scope of the inventive concepts described herein.

FIG. 2C shows a detailed flowchart of actions that are performed to perform step 202, for the preparation and configuration of the client-side environment. At 212, the resource shim client is installed inside the container image. In some embodiments, this involves embedding an executable or library within the container image at build time. By including the shim as part of the container image, the system ensures that the instance of the container has the capability to intercept workload execution and redirect it to a remote server. Alternative embodiments may mount the shim dynamically at container startup rather than embedding it into the image, thereby allowing shim upgrades without rebuilding the container image.

At 214, Auth credentials are passed to the container, e.g., via an environmental variable. The authentication credentials may also be provided using other approaches as well in alternative embodiments, e.g., through a secure secrets manager, mounted volumes, or encrypted tokens. The credentials authenticate the shim to the orchestration layer or the remote execution service, thereby ensuring secure association of the client container with the remote resources.

At 216, a configuration file may be configured. For example, the configuration file may be configured to describe the GPU needs for the workload to include workload-specific requirements, such as GPU type, memory capacity, number of cores, or other hardware features. The configuration file may also specify software-level parameters, such as supported frameworks (e.g., TensorFlow, PyTorch) or language runtimes. By defining these parameters, the system can select an appropriate remote server and adapt the workload's software environment as needed. In alternative embodiments, such configuration may be dynamically generated by a policy engine rather than statically defined.

At 218, filesystem paths may be configured. These paths may map portions of the client machine's filesystem to be accessible from the remote server through the secure tunnel. This configuration enables workloads to access private datasets, AI models, or other sensitive assets located on the client machine. In some embodiments, path configuration may include fine-grained access control, specifying read-only versus read-write access, or mapping only a subset of directories. Such mechanisms permit workloads to use private or proprietary data securely, without requiring wholesale duplication of the client filesystem at the remote server. As described in more detail below, this action may be performed to facilitate the use of private AI operations.

At 220, the container entry point may be configured. In some embodiments, the entry point is modified to invoke a “cloud execution” wrapper executable prior to launching the workload. The wrapper may parse the configuration, authenticate the session, and initiate the shim client, thereby ensuring that all workload invocations are transparently redirected to the remote server. In alternative embodiments, the entry point may be configured to invoke a script that sets up environment variables, mounts remote filesystems, and then launches the workload.

This portion of the document will now provide a description of how filesystems are interacted with according to some embodiments of the invention.

As used herein, the term “filesystem” includes by way of example, at least OS, libraries, frameworks, language runtimes, and local data. When the filesystem “follows” the workload, it will function in a consistent manner, regardless of the physical hardware on which it is running. Embodiments of the invention achieve this by remote mounting the filesystem from the client machine (where the workload is supposed to be running originally) on the server machine (where the workload is running).

Some implementations of the invention can handle caching of frequently used data. What this does is to avoid requiring all data accesses to go over a network through the tunnel to access data at the filesystem of the client machine. Instead, by caching data at the remote server, this allows more efficient access to data with the expense of a network roundtrip. It is noted that consistency models can be applied to ensure that updates to files are reflected correctly across both client and server environments.

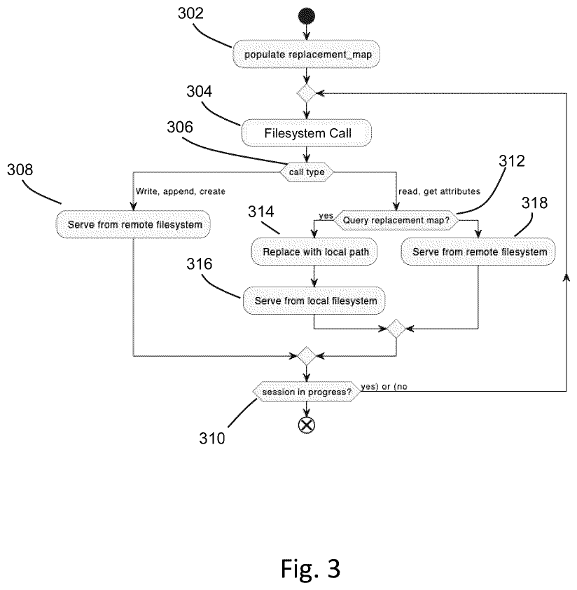

FIG. 3 shows a flowchart of an approach to implement caching according to some embodiments. The approach of FIG. 3 shows the mechanism for multiplexing (MUX-ing) between two filesystems: (i) the filesystem at the remote (GPU server); and (ii) the network-mounted filesystem from the client machine.

The process starts with a replacement map being populated (302). In some embodiments, the approach loads a previously populated replacement_map, which is a data structure that maps the original file path (from the client machine's filesystem) to a replacement file path (on the GPU server's file system). The replacement map is a structure that includes a list of file system paths as well as a map to their location in either a first location in the original client file system or to a second location that is local to the remote server.

The logic then waits for session to begin. Once active, a resource shim filesystem call is received (304). This action may occur if the workload seeks to access a file in the filesystem. The intercepted call may request any standard filesystem operation, such as open, read, write, append, create, or delete.

In some embodiments, a determination is made of the specific call type of the call (306). For each filesystem call that comes through, the logic classifies it in two buckets—Modify (Write, append, create) or Read (Read, get attributes). The general idea of this approach is that for operations that involve writes, appends, or creates, the call should be served from the remote filesystem (308) (remove from the current location of the workload at the remote server and handle at the client system).

However, for calls that pertain to reads or get attributes, the flow would query the replacement map to determine the location (312). If the replacement map identifies the location to be from the remote filesystem, then the call is served from the remote filesystem (318). On the other hand, if the intent is to service from the local file system, then replace with a local path, and serve from the local filesystem (316). Modify filesystem calls are always served from the remote, network mounted filesystem, such that file modifications get natively made on the client filesystem. Recall that client filesystem is the one remotely mounted via network on the GPU server. Read filesystem call are further analyzed by “Query replacement_map” stage. If the replacement_map has an entry for the original path, then replace it with local path and serve the file read from local filesystem. Otherwise, serve the file read operation from remote (client's) filesystem.

Next, a check is made whether the session is still in progress (310). As long as the workload session remains active, the system loops to receive subsequent filesystem calls and applies the same decision process. Upon session termination, cached data may be invalidated, retained for reuse, or synchronized back to the client filesystem, depending on the embodiment.

An alternative embodiment may bypass call-type classification altogether. In such a configuration, any filesystem calls—whether reads or writes—may be routed either to the local server filesystem or to the client filesystem, depending on a policy or contents of the metadata/replacement maps. For instance, certain workloads may be executed entirely from a replicated server-side filesystem without requiring client-side access. In this alternate embodiment, only the right-hand side of the figure is needed.

Therefore, embodiments of the invention provide an approach for allowing the filesystem layer to intelligently decide (on a file-by-file basis) where to serve the file reads from. This allows workloads to benefit from caching and performance improvements at the server while preserving consistency and security of client-side data.

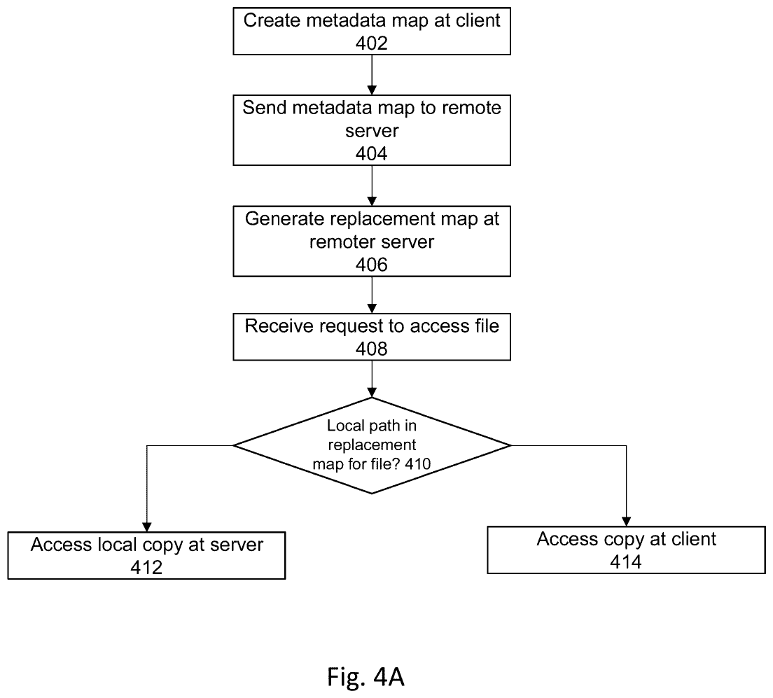

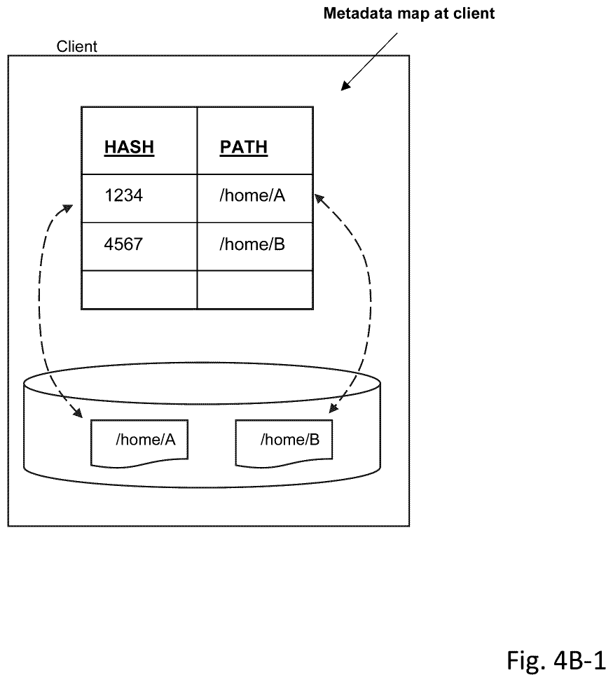

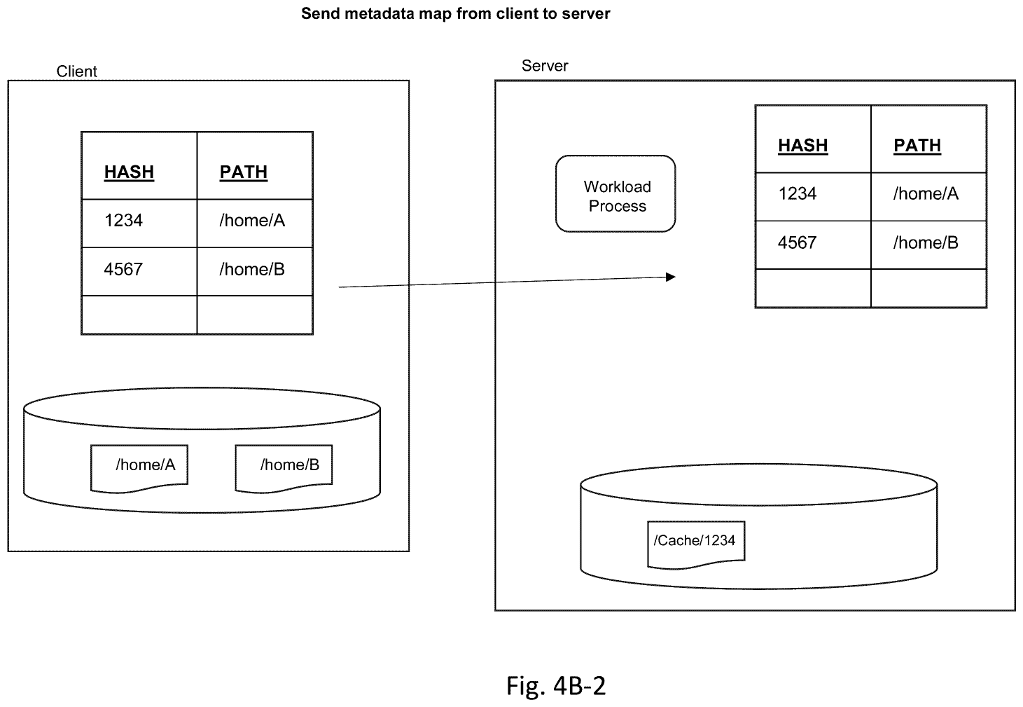

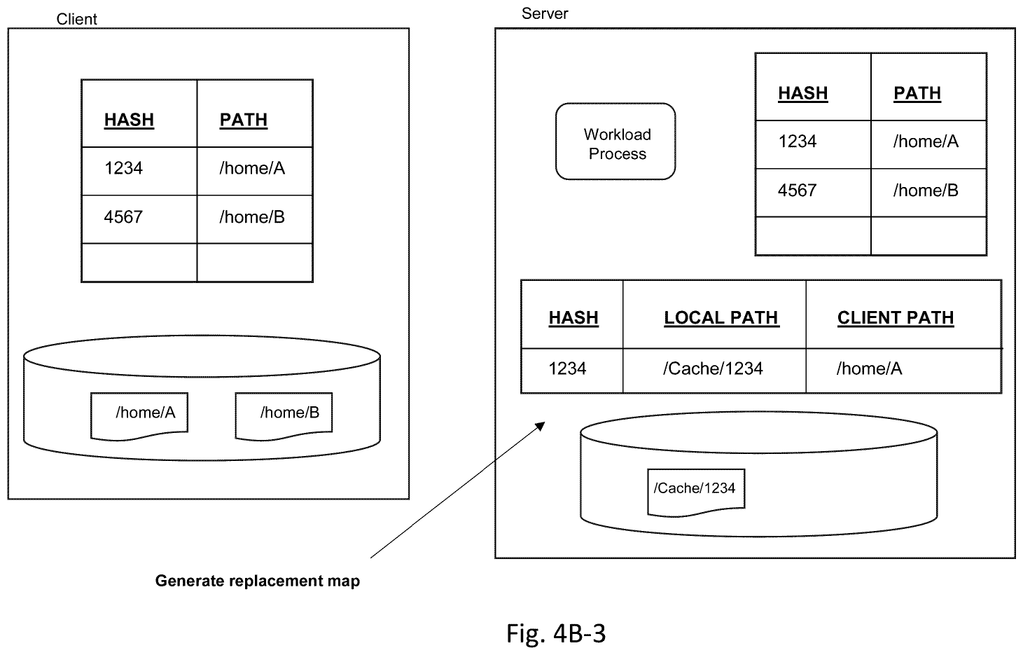

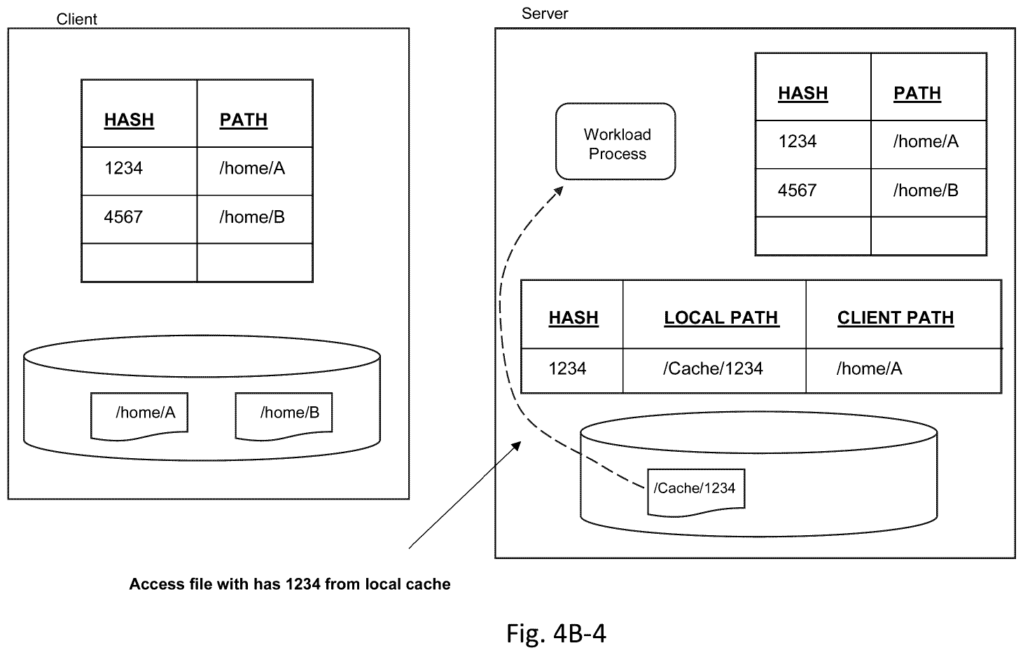

FIG. 4A shows a flowchart of an approach to implement and maintain replacement maps. At 402, a metadata map is created at the client system, where this map comprises a list of content to be accessed by a workload process at a remote server. The metadata map functions as a manifest of content that may be accessed by a workload process once executed on a remote server. Each item on the list includes, for example, identification of a file currently accessible at the client system that may be accessed for workload processing. The metadata map includes various items of information. For example, the metadata map may include a file/pathname for a given content item, as well as a hash value for the content. A file hash is a unique, fixed-length string of characters, like a digital fingerprint, generated from a file's content using a mathematical algorithm. It can be used to verify a file's integrity and confirm that its content has not been altered, because even a tiny change to the file can produce a completely different hash. It can also be used to confirm the identity of a file regardless of any changes to the filename for that file. SHA-256 is an example of a file hash that is commonly used.

At 404, the metadata map may be sent to a remote server. This transmission may occur concurrently with, or prior to, the assignment of a workload process to the remote server. This map may be sent in conjunction with the assignment of a workload process to that remote server. The metadata map equips the server with sufficient information to determine whether it can satisfy workload file requests using local resources without needing to repeatedly query the client.

At 406, a replacement map is generated at the remote server. The idea behind the replacement map is that some or all of the content to be accessed by the workload at the remote server may actually be located/cached at the server. In this situation, it is more efficient to simply access that content at the server than to send a request for that content to be sent across the network from the client to the server. The replacement map includes a listing of the locally stored items at the server that can serve to “replace” the need to seek those items from the client. Whereas the metadata map describes files available at the client, the replacement map identifies which of those files (or equivalents) are already cached or otherwise present at the server.

At 408, a request may be received to access a file at the remote server. The request may be issued by the workload process at the server. A determination is made at 410 whether the requested item is represented in the replacement map with a local location. If so, then at 412, that item is served to the workload from the local copy. If not, then at 414, that item is retrieved from the client. Therefore, if a match exists, the file request is redirected to the server's local copy, enabling faster access and reduced network usage. Even if the file is not found in the replacement map, the request is forwarded to the client system for retrieval, after which a local cached copy may optionally be stored and recorded in the replacement map for future requests.

FIGS. 4B-1 to 4B-5 provide an illustrative example sequence of this processing. FIG. 4B-1 shows a client system having two items of data stored at that client. A first item is at the file path “/home/A” and the second item is at the file path “/home/B”. The file hash for the first item at path “/home/A” is “1234”. The file hash for the second item at path “/home/B” is “4567”.

A metadata map has been created with entries that correspond to these two items. Each row of the metadata map includes a first column that identifies the file hash for an item, along with a second column that identifies the file path for that item. In the example scenario shown in the figure, the metadata map includes a first row that represents the item at path “/home/A” with a hash value of “1234”. The metadata map also includes a second row that represents the item at path “/home/B”with a hash value of “4567”.

As shown in FIG. 4B-2, when a workload process is instantiated at the remote server, a copy of the metadata is also sent to that remote server. As can be seen in this figure, the remote server now includes the workload process as well as a copy of the metadata map.

Next, as shown in FIG. 4B-3, a replacement map is created at the server. It is possible that some or all of the items of the items listed in the metadata map has been previously copied from the client to the server, and are now currently still located somewhere at the server. The replacement map can be used to identify the local locations of those items.

In some embodiments, the filename of the items held at the server are used to identify the hash value for that item. For example, if a given file has a hash value of “1234”, then a “1234” will be used to represent some or all of the filename for that item. The list of filenames at the server can therefore be used to match to the “hash” column of the metadata file, and any matches would therefore be included as an entry in the replacement map.

In the current example in FIG. 4B-3, it can be seen that a file already exists at the server with the file/pathname “/Cache/1234”. In this example scenario, the “1234” filename for this file represents the hash value for that file. This matches the file having the pathname “/home/A” in the metadata map. Therefore, an entry can be created in the replacement map that includes the hash value for this file, the local location at the server for this file, along with original pathname for this file at the client.

As shown in FIG. 4B-4, a request may later be sent from the workload process to access the file at pathname “/home/A”. In this situation, a check can be made of the replacement map to determine whether this file exists in the replacement map. Here, since an entry for that file does exist in the replacement map, this means that the request from the workload can be serviced from a local copy of the file at “/Cache/1234” rather than going across the network to retrieve that file from the client.

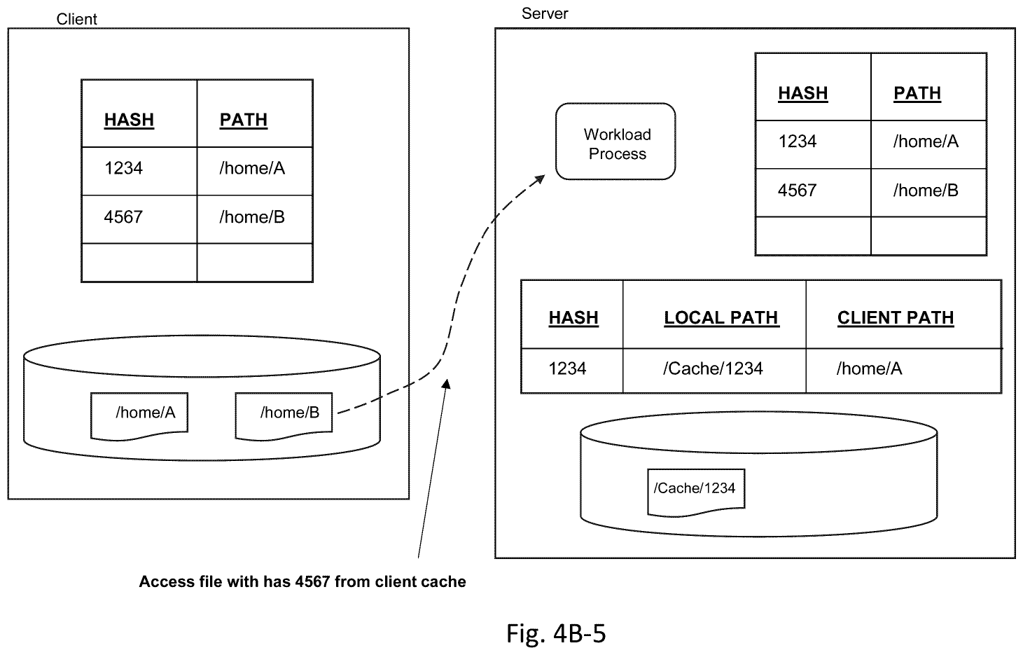

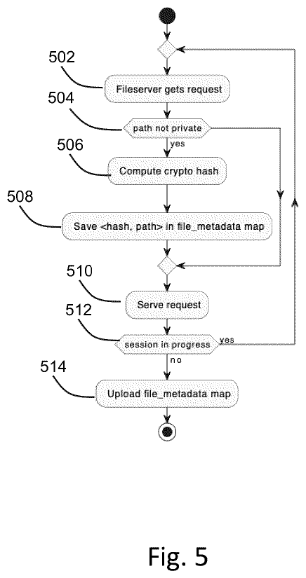

As shown in FIG. 4B-5, a request may later be sent from the workload process to access the file at pathname “/home/B”. A check can be made of the replacement map to determine whether this file exists in the replacement map. Here, since an entry for that file does not exist in the replacement map, this means that a request must be sent for a copy of the file from the client rather than locally servicing the request with a local copy.

There are numerous additional optimizations that can be done with caching in additional embodiments of the invention. For example, one approach can be to perform copying of data from the client machine to server machine in a “just-in-time” manner, where data is cached on an as-needed basis. Another possible approach is by anticipating and speculatively fetching data from client to server, e.g., where prefetching is performed to retrieve and cache data in a predictive manner.

Another possible approach is to implement caching of data on the server while being sensitive to user's privacy preference. FIG. 5 shows a flowchart of an approach to implement user-privacy aware caching according to some embodiments of the invention.

This figure shows the mechanism for populating cache on server, in a way that is sensitive to data privacy. While a session is in progress, the client machine receives a filesystem request (502). A decision is made, based on the path, about the data privacy of the file (504).

The determination is made as to whether the requested file path corresponds to content that is considered “private” under a set of privacy rules or policies. Such rules may be configured by a user, administrator, or enterprise system, and may include: (i) specific directory prefixes (e.g., “/home/private/*”), (ii) pattern-matching rules (e.g., files with extensions such as “. key” or “.pem”), (iii) metadata tags or attributes (e.g., “confidential”), or (iv) dynamically supplied user input at runtime.

If the path is not private, then it qualifies for caching on the server. At 506, a cryptographic hash of the file contents is computed (e.g., SHA-256 or BLAKE3). This hash functions not only as an integrity check but also as a privacy-preserving identifier. Specifically, the server can identify and deduplicate files by hash value without needing to know the actual file contents or filename.

A tuple <Hash, PATH> is saved in the file_metadata map data structure (508). This metadata map represents a linkage between the client's local filesystem path and the content fingerprint. In contrast, if the file path is deemed private under the policy, then no tuple is stored for that file, and the corresponding file is never cached at the server.

After updating the data structure, the fileserver serves the request (510), and repeats while the session is in progress (512). At the end of the session, the file_metadata map data structure is uploaded to the server (514). Now the server knows how to map a path on the client filesystem to a file on the local filesystem that has the same crypto hash. This enables the server to associate client filesystem paths with previously cached local files based on their cryptographic hash. Importantly, because private files were excluded from the map, the server gains no visibility into their existence or contents, thereby preserving privacy guarantees.

Thus, embodiments of the invention provide a privacy-sensitive caching mechanism that allows workloads to benefit from efficient server-side caching and deduplication, while ensuring that user-designated private data is never exposed outside the client system.

Some embodiments allow for the implementation of “private AI” or more generally “private workloads”. In this embodiment, one can train and do inference using confidential data hosted on-premises yet use remote GPUs from a cloud provider. In this scenario, the workload could be running on the client machine, which is on-prem and inside the security perimeter. The stack running on the client machine opens a secure tunnel to a remote server that has the GPUs. The filesystem (including the datasets, which may be part of the filesystem) is mounted over the network using remote mounting. The workload could be running on the server and fetches the data in real time as needed over the network tunnel from client machine's filesystem. Since the data is not saved on the serve disk, and the server workload is running under a confidential computing environment, the data stays private and secure.

An alternative embodiment corresponds to the reverse situation, where the processing is performed in a private manner at a remote server. For example, consider if a user or customer possesses some private data that needs to be operated by a service provider, but perhaps for confidentiality or privacy reasons, the user does not want to allow that private data to leave the customer's secure facilities to be sent to the remote service provider. With embodiments of the invention, the remote service provider can be considered the client machine having a workload (e.g., the service provider's proprietary algorithm or service). The remote server could be considered the location at which the customer has its private data and underlying hardware to perform the services. The current invention can be used to send the service provider's workload to that user's remote server so that the service provider's workload can be used to operate upon the customer's private data at the customer's own facilities using the customer's own resources. This allows the proprietary algorithm running in a SAAS (software as a service) model to be transparently used in a “private” manner, without exposing the client/user's private data to the service provider's facilities or to other 3^{rd} parties, and without requiring any additional changes to the client's or service provider's work processes.

This portion of the disclosure will now discuss the implementation of the network tunnels, which provide the mechanism by which workloads executing remotely can appear to be executing local. With network tunnels, the software stack automatically handles all network packet routing, such that network packets originating from the workload running on a remote server appear to be originating from the client machine.

This effect is achieved through multiple coordinated steps. First, a secure, encrypted tunnel is set up between the client and server. In some embodiments, the tunnel may be implemented using a virtual network interface such as Linux TUN/TAP, WireGuard, or OpenVPN. Once the tunnel is created, a routing table can be modified on the remote server, such that every packet originating from the workload process (and its children) is routed through the tunnel. On the client side, the shim component acts like the original workload process, in that the socket connection to the outside world originates from this process just like before. Thereafter, all incoming network packets destined for the workload process are transparently received by the shim and forwarded through the tunnel to the actual workload at the server.

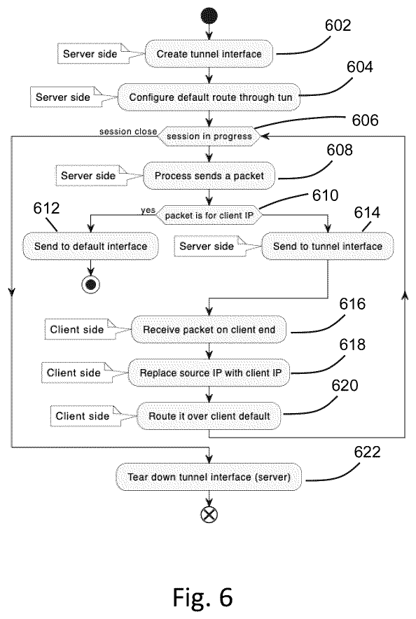

FIG. 6 shows a flowchart of an approach to implement tunnelling according to some embodiments of the invention. At the server, a tunnel interface is created (602). The system may create a tunnel interface using Linux TUN/TAP on the server machine, e.g., allocating a TUN/TAP device and associating it with the workload's network namespace.

Next, a default route through the tunnel is configured (604). This ensures that all network traffic generated by the workload process is routed into the tunnel by default, rather than exiting directly through the server's physical network interface.

While the session is in progress (606), the process may send a packet at the server (608). For each outgoing packet, the system determines whether the packet should be routed through the client machine (610). If not (e.g., for internal server-side communication), the packet may be routed through the default server interface (612). If so, the packet is routed into the tunnel interface (614).

At the client side, the packet is received through the tunnel (616). At 618, the source IP address is rewritten to match the client machine's IP address, thereby ensuring that downstream entities (e.g., external APIs, peer nodes, firewall rules) recognize the packet as originating from the client machine. In effect, the client machine is acting as a NAT or masquerading endpoint for the workload traffic. At 620, the rewritten packet is then transmitted through the client's default interface to its intended destination.

Once the workload has finished its processing, then the tunnel interface can be torn down and resources released (622). This teardown operation may include removing routing table entries, revoking tunnel encryption keys, and deallocating the virtual network interface.

In alternative embodiments, more advanced tunneling strategies may be employed. For example, tunnels may be dynamically migrated between servers as workloads move, without interrupting external connectivity. Multipath tunneling may be used to increase throughput or resilience, distributing traffic across multiple parallel tunnels. In some implementations, QUIC- or UDP-based tunnels may be used to reduce latency for real-time workloads such as streaming or inference serving.

Embodiments of the invention therefore provide a robust tunneling mechanism that preserves the illusion of local workload execution, enforces security via encryption, and supports high performance through flexible routing, while maintaining transparency to external systems and users.

This disclosure will now describe an approach to implement mutable environments, wherein the operating environment of a workload, as observed through its filesystem, can be altered dynamically. This capability allows workloads to execute in a target environment different from their original client environment, without requiring modification of the workload itself. The software environment, as seen through the lens of the filesystem, can be changed by applying patches at the runtime when individual files are being accessed for read.

In some embodiments, mutability is achieved through the use of a custom, target-environment-specific replacement_map. The replacement_map associates original file paths on the client machine with new, local file paths on the server, thereby providing transparent substitution of files, libraries, frameworks, or runtime binaries as needed for the target environment. Some embodiments operate by loading a custom, target-environment specific replacement_map that maps a file path on the client machine to a new, local file path on the server.

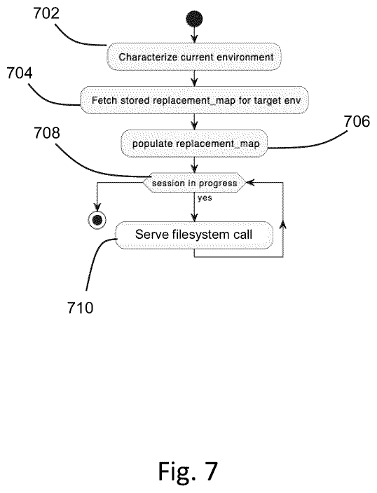

FIG. 7 shows a flowchart of an approach to implement mutable environments. This figure shows the mechanism by which software operating environment can be changed transparently. The process begins by characterizing the current environment (702). During this step, the system analyzes the contents of the client filesystem, including operating system binaries, libraries, frameworks, language runtimes, and configuration files. This characterization provides a precise understanding of the workload's dependencies and requirements.

Based on this characterization, the system determines whether the workload is feasible to map to a different environment (704). Factors influencing feasibility may include compatibility of the workload's dependencies with the target environment, licensing restrictions, hardware-specific constraints, and historical mapping success data. If the workload is considered “mappable,” the system retrieves a previously created mapping between the current environment and the target environment. This is a mapping between each file on the client system, and its equivalent or replacement file.

In the “populate replacement_map” step (706), the system constructs a data structure that maps each file on the client system to its corresponding replacement in the target environment, represented as <Original, Replacement> file paths. In some embodiments, the replacement_map may support additional metadata, such as version information, conditional rules (e.g., “use replacement only if GPU architecture is X”), or fallback paths. If the workload is deemed unmappable, then the replacement_map is just an empty map, and the workload proceeds without substitution.

While the session is still in progress (708), then the workload/shim call will be served through the target environment (710). The replacement_map is consulted dynamically to determine the appropriate file to present to the workload. In this manner, the workload transparently accesses files from the target environment without knowledge that the underlying filesystem differs from the original client environment.

This approach therefore enables the workload to run in an entirely different environment from the one on the client. By leveraging this mechanism, embodiments of the invention decouple workloads from their original software environments, allowing seamless migration across heterogeneous systems while preserving workload functionality and enabling runtime optimizations. One can use such a flexibility for numerous purposes. For example, security patching can be implemented, e.g., where outdated or vulnerable libraries can be replaced dynamically with patched versions without requiring modification of the workload. In addition, performance upgrades can be provided, e.g., where workloads can be adapted to take advantage of high-performance libraries or specialized hardware drivers available on the server. Furthermore, workloads can now be run on a different GPU architecture, e.g., where workloads initially tied to a specific GPU architecture or operating system can be run on a different server architecture through replacement of dependencies. Testing can be implemented, where workloads can be executed in alternate environments to verify behavior or isolate potential faults.

This next portion of the disclosure will now describe an approach to implement orchestration and matchmaking logic according to embodiments of the invention. This is an approach that enables moving away from specific hardware SKU (CPU model, GPU model, speeds and feeds) to a performance based, runtime decision of which hardware resources are most suitable for a given workload.

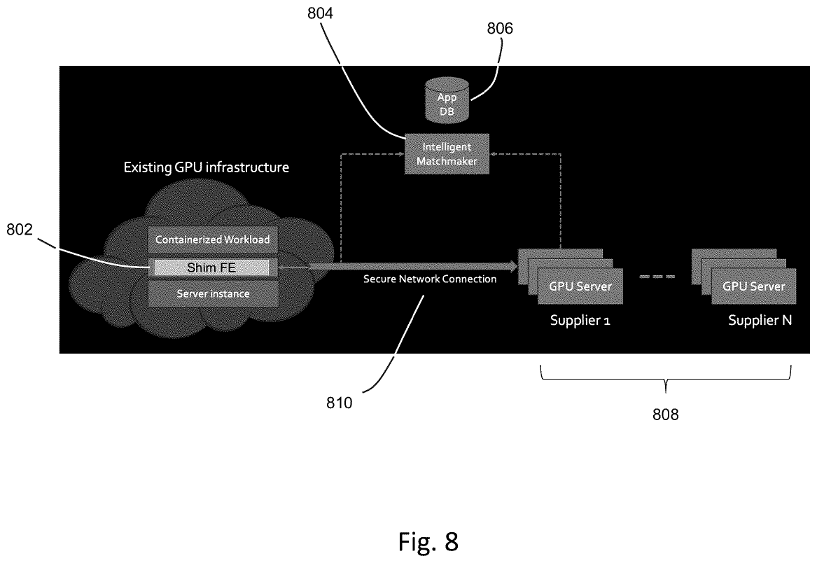

There are some components that may be used to implement this feature. As shown in FIG. 8, one component is an “App-DB” 806, which a continuously growing database of application and hardware telemetry. This can be implemented as a continuously updated repository of telemetry describing both workload behavior and hardware characteristics. This may include historical execution times, memory consumption, GPU utilization, network usage, cache hit rates, and other performance metrics. The App-DB allows the system to predict how a given workload will perform on available hardware. A matchmaker model (within or associated with an intelligent matchmaker module 804) may also be used. This can be implemented as a ML (machine learning) based model that chooses the best-fit hardware configuration (the output) for a given workload and performance combination (the input). The model can take as input the workload requirements (e.g., memory, GPU compute needs, expected throughput, latency constraints) and outputs the best-fit hardware configuration. The model may be trained using historical workload performance data from the App-DB, and may incorporate optimization objectives such as efficiency, cost, or latency.

FIG. 8 shows the distributed system architecture. The workload is running on the left side, in existing cloud infrastructure with GPU machines. At the start of workload, the shim FE (Frontend, and also referred to herein a resource_shim frontend) 802 queries the intelligent matchmaker 804, which in turn queries the App DB 806 for the best GPU that for the given application and its performance needs. The available GPU resources may originate from multiple suppliers 808, allowing flexibility in hardware selection.

Once the GPU is identified, the shim FE opens a secure network tunnel 810, mounts local OS facilities on the remote server, and spawns the workload on the chosen server. This ensures the workload executes on hardware that meets its performance needs while maintaining the appearance of local execution to the client.

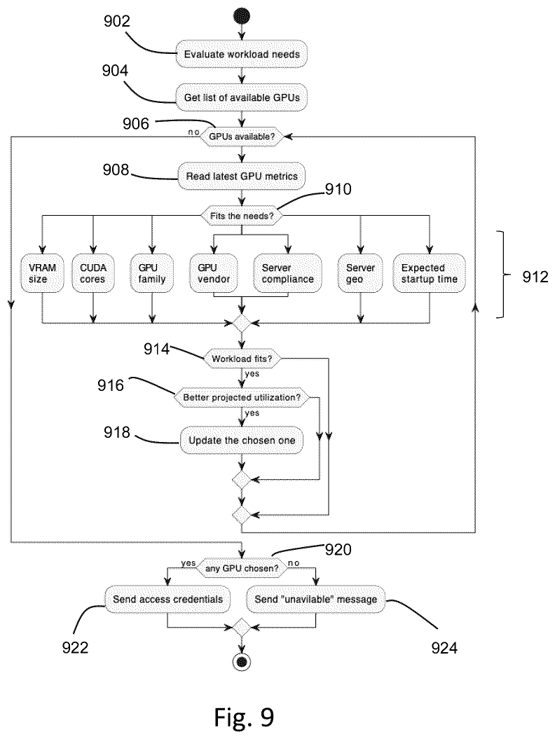

FIG. 9 illustrates a flowchart of an approach for matchmaking workloads to optimal hardware according to some embodiments of the invention. This process enables performance-driven hardware selection, decoupled from fixed hardware SKUs, and ensures that workloads are dynamically assigned to servers that can best satisfy their requirements.

The process of matchmaking begins with evaluating of workload needs at 902. This is done by referring to the App DB, which is a comprehensive database of workload performance and resource consumption. This step involves analyzing the workload's resource requirements, performance goals, and any constraints specified by the user or system policies. Metrics considered may include expected memory usage, GPU compute demand, latency tolerance, I/O patterns, and historical performance data captured in the App-DB.

Next, the system queries the GPU servers available in the fleet (904). This step operates to identify candidate servers for the workload. The available servers may include heterogeneous hardware from multiple vendors, with varying GPU models, VRAM capacities, network connectivity, and geographic locations.

For each candidate server for a given GPU, the system then retrieves telemetry and performance metrics/statistics to get up-to-date information (906). Example of such metrics may include: (1) Current GPU utilization and free VRAM; (2) Number of available CUDA or other processing cores; (3) Firmware and driver versions; (4) Current server load and network bandwidth availability; (5) Cache state, including pre-loaded datasets or libraries relevant to the workload.

The system then compares the GPU metrics with workload needs, along several dimensions (910). Example of factors that may be considered include VRAM size, CUDA cores, GPU family, GPU cores and architecture, GPU vendor and family, Server compliance levels/certifications, Server geographic location, Expected startup time (912). Expected start up time is particularly interesting, as it depends upon the state of the cache at the moment on the server.

If the workload needs are met by the GPU in question (914), then the system further evaluates what would be the projected utilization on the GPU server after the workload starts running there. The objective is to select a GPU that not only meets the workload needs but also maximizes resource efficiency or overall system performance. If the projected utilization is better than previously considered candidates (916), then the system updates the current chosen candidate to be this particular GPU (918).

The process continues iteratively for available GPUs in the fleet. After evaluating the available GPUs, the system determines whether a suitable GPU has been selected. If a suitable GPU has been chosen (920), then the system passes the access credentials and connection information for the GPU server (922), enabling the workload to be transparently moved and executed on that hardware. If no suitable server is identified, an “unavailable” response is sent to the client (924), prompting potential retries or fallback behavior.

In some embodiments, the matchmaking process may incorporate additional features and optimizations. For example, machine learning-based prediction may be employed, where historical telemetry is used to predict performance on candidate GPUs. Multi-objective optimization can be used to balance trade-offs between latency, cost, energy efficiency, and server utilization. Cache-aware selection can be applied to prioritize servers with preloaded datasets or frequently accessed software dependencies. Load balancing may occur to assign workloads to optimize cluster-wide performance. Geographic or regulatory constraints may exist, where workloads should run on servers that satisfy location-based or compliance requirements.

By integrating real-time telemetry, historical performance data, and predictive modeling, embodiments of the invention provide a robust, automated matchmaking framework that dynamically selects optimal hardware for workload execution. This enables seamless decoupling of workloads from their original environment while maximizing performance, resource utilization, and compliance with user or system policies.

This portion of the disclosure will now discuss the concept of GPU arbitrage, which enables workloads to leverage GPU resources from alternative cloud vendors while continuing to execute within a client-specified cloud environment. There are variety of reasons why workloads sometimes must run in a specific cloud environment such as AWS/Azure/GCP. These reasons (vendor-lock in) prevent cloud customers from benefiting from cheaper and plentiful GPU supply available from other vendors. Such constraints prevent users from exploiting cost-efficient or higher-performance GPU resources available from other vendors or cloud regions.

With the currently described technology, this is no longer the case. Embodiments of the invention overcome these limitations by decoupling the workload execution environment from the underlying hardware location. Using the combination of remote workload execution, secure network tunnels, and resource shims, a workload continues to appear as though it is executing within the original client instance, even when the actual GPU resources are hosted on an external cloud vendor. The workload can continue running inside AWS/Azure/GCP instance (the client machine), and benefit from GPUs hosted by other cloud vendors.

In operation, the workload initially runs on the client machine within the original cloud environment. The shim component intercepts workload execution and transparently moves computationally intensive tasks to a remote GPU server located in a different cloud provider or region. A secure tunnel ensures all network traffic, filesystem access, and inter-process communication appear local to the client, thereby preserving application transparency and compatibility.

The system can dynamically select GPU servers based on performance, cost, availability, or user policy. For example, a workload may be executed on a high-performance GPU in a cost-efficient region or vendor, even if the client instance is bound to AWS. Telemetry and matchmaking logic ensure that the remote GPU satisfies the workload requirements while minimizing latency and optimizing utilization.

Accordingly, embodiments of the invention provide a mechanism for cross-cloud GPU utilization that preserves the client-side execution illusion, improves cost and performance efficiency, and eliminates vendor lock-in, all while maintaining transparency, security, and compliance for the workload.

This portion of the disclosure will now discuss the concept of workload porting, which addresses the challenge of running AI workloads across heterogeneous GPU architectures. AI workloads are written in Python using higher level libraries such as PyTorch. The workloads can be run on non-NVIDIA GPUs (Intel, AMD, Qualcomm, others), technically speaking. In practice, the work involved in setting up a new software environment is non-trivial. The burden comes from: (1) compatibility; (2) testing and validation; (3) long term maintenance. Regarding compatibility, different GPUs and their drivers may require distinct library versions, compiler flags, or specialized APIs. Frameworks such as PyTorch or TensorFlow often include hardware-specific optimizations that must be correctly configured for the target GPU. Regarding testing and validation, even if the workload runs, subtle differences in computation, floating-point behavior, or kernel execution can affect correctness, requiring extensive validation. Regarding long-term maintenance, maintaining separate software environments for multiple GPU types is resource-intensive, particularly when libraries and dependencies are updated frequently.

The mutable environment feature of the current embodiments greatly simplifies workload porting. The system provides a library of curated environment patches that encapsulate all the changes needed to make the workload compatible with the new hardware. By leveraging the replacement_map and curated environment patches, the system automatically adapts the software environment for the target GPU. The replacement_map can substitute OS binaries, library files, runtime components, or configuration settings in real time as the workload accesses them, ensuring compatibility without modifying the workload code.

The system can maintain a library of curated environment patches, each encapsulating all modifications necessary to make a workload compatible with a specific GPU type or architecture. When porting a workload, the system automatically selects the appropriate patch based on the detected target hardware and applies it dynamically via the mutable environment mechanism. This eliminates the need for manual reconfiguration, recompilation, or extensive testing by the user.

As a result, embodiments of the invention enable trivial porting of AI workloads across diverse hardware, including heterogeneous GPU vendors and architectures, without requiring changes to the original workload code. This facilitates broader adoption of GPU resources, reduces operational overhead, and enhances flexibility in distributed and cloud-based AI execution environments.

Embodiments of the invention can provide for improved infrastructure efficiencies. The ability to move workload from machine to machine, without any setup time, results in higher utilization of servers. This is particularly so for interactive workloads, where users tend to setup a machine and hold on to it, to avoid having to setup another machine.

By enabling dynamic workload migration between machines without requiring manual setup or environment reconfiguration. Traditional workflows, particularly for interactive AI workloads, often result in underutilized servers because users pre-allocate machines and maintain them for extended periods to avoid the effort of repeated environment setup and dependency installation.

By contrast, in embodiments of the current invention, workloads can be transparently moved between machines, leveraging the combination of the shim component, remote execution, network tunneling, and mutable environments. Since the workload can continue to appear as if it is running locally while actually executing on a different server, the system eliminates setup overhead and idle times associated with traditional machine assignment.

This capability enables higher overall server utilization. Machines that would otherwise remain idle or partially used can be dynamically assigned workloads from multiple clients, maximizing the computational resources available at any given time. The system can also make real-time decisions about workload placement based on current hardware utilization, network conditions, and performance requirements, further enhancing efficiency.

In addition to improving utilization, this approach allows for rapid scaling and elasticity in cloud or data center environments. Interactive workloads can seamlessly migrate to available high-performance servers as needed, without requiring user intervention or manual provisioning. This reduces operational costs, improves resource allocation, and enhances user experience by minimizing wait times for compute availability.

Overall, embodiments of the invention provide a flexible, efficient, and automated infrastructure management mechanism that optimizes server usage, reduces idle resources, and ensures interactive workloads receive the computational resources they need, while maintaining transparency to users.

Embodiments of the invention can also provide efficient upgrade paths for edge devices. Edge devices, such as smart cameras, IoT sensors, or video analytics systems, often remain in operation for many years. It is very expensive to physically replace edge hardware boxes. With the current invention, the software running on the edge device (for example, a smart video surveillance system) can still run on the same physical device but use a higher power GPU from the network, with no changes needed from the software.

Using the techniques described herein, software running on an edge device can continue to execute on the existing physical hardware while offloading computationally intensive tasks, such as AI inference or video processing, to higher-performance GPUs located elsewhere in the network. The combination of the shim component, remote execution, and secure network tunneling ensures that this offloading is transparent to the edge software and to users.

The system allows the edge device to maintain its original software environment, dependencies, and configuration, while dynamically leveraging the remote GPU resources. In some embodiments, mutable environments and replacement maps can be applied to adjust the execution environment for compatibility with the target GPU architecture, further ensuring seamless operation without software modification.

This approach provides several key benefits for edge deployments. Cost-effective upgrades can be provided, where edge devices can gain access to higher-performance GPU resources without physical replacement. Extended device lifetime can be achieved, where legacy hardware remains operational while benefiting from modern compute resources. Transparent software operation can be implemented, where existing applications require no changes to exploit network-available GPU acceleration. In addition, flexible deployment scaling can occur where multiple edge devices can dynamically share remote GPU resources based on workload demand.

Accordingly, embodiments of the invention enable dynamic, network-based GPU augmentation for edge devices, providing an efficient, scalable, and cost-effective mechanism for extending the capabilities and operational lifespan of deployed edge hardware.

The foregoing description of embodiments of the invention has been presented for purposes of illustration and description. It is not intended to be exhaustive or to limit the invention to the precise forms disclosed. Those skilled in the art will recognize that modifications and variations can be made without departing from the scope of the invention.

Embodiments of the invention provide a comprehensive framework for decoupling software workloads from the underlying hardware, enabling dynamic execution of workloads on remote servers while preserving the appearance of local execution. The inventive techniques include, among other features, remote workload execution, secure network tunneling, resource shims, mutable software environments, replacement maps, caching mechanisms, intelligent matchmaking, GPU arbitrage, workload porting, and edge device offloading.

These features collectively allow workloads to run efficiently across heterogeneous hardware environments, optimize resource utilization, reduce operational overhead, maintain security and privacy, and facilitate cost-effective access to high-performance computing resources. Embodiments of the invention further enable transparent workload migration, cross-cloud execution, and seamless upgrades for edge devices, while ensuring compatibility, performance, and reliability.

While the disclosure has focused on AI and containerized workloads for illustrative purposes, it will be recognized that the inventive concepts are broadly applicable to other computing workloads, virtual machines, and software systems requiring dynamic hardware allocation, performance optimization, and environment adaptability.

Accordingly, the scope of the invention is intended to be defined by the claims appended hereto, rather than by the specific embodiments and examples described above. The described embodiments provide a flexible, scalable, and efficient approach to workload execution that overcomes limitations of conventional tightly coupled hardware-software systems.

### SYSTEM ARCHITECTURE

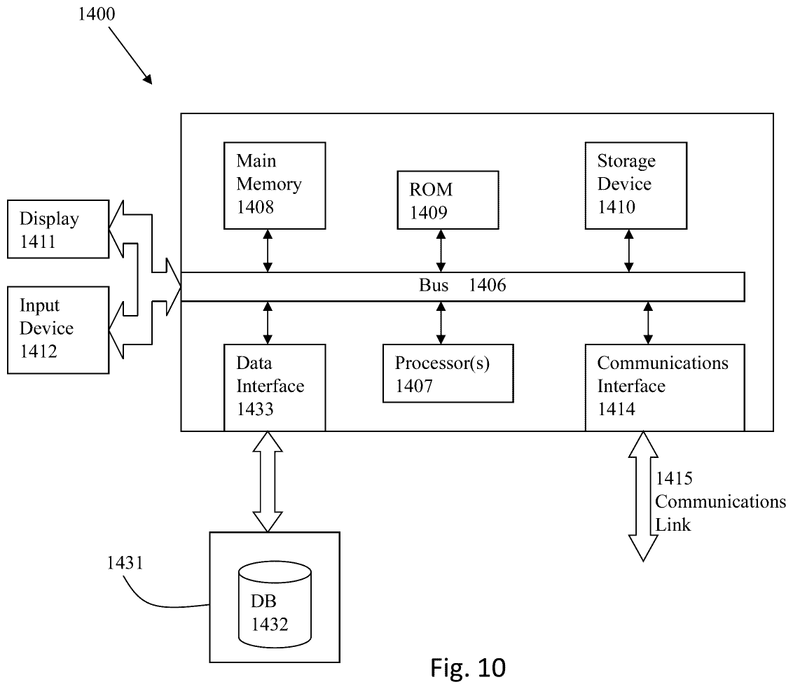

FIG. 10 is a block diagram of an illustrative computing system 1400 suitable for implementing an embodiment of the present invention. Computer system 1400 includes a bus 1406 or other communication mechanism for communicating information, which interconnects subsystems and devices, such as processor 1407, system memory 1408 (e.g., RAM), static storage device 1409 (e.g., ROM), disk drive 1410 (e.g., magnetic or optical), communication interface 1414 (e.g., modem or Ethernet card), display 1411 (e.g., CRT or LCD), input device 1412 (e.g., keyboard), and cursor control.

According to some embodiments of the invention, computer system 1400 performs specific operations by processor 1407 executing one or more sequences of one or more instructions contained in system memory 1408. Such instructions may be read into system memory 1408 from another computer readable/usable medium, such as static storage device 1409 or disk drive 1410. In alternative embodiments, hard-wired circuitry may be used in place of or in combination with software instructions to implement the invention. Thus, embodiments of the invention are not limited to any specific combination of hardware circuitry and/or software. In some embodiments, the term “logic” shall mean any combination of software or hardware that is used to implement all or part of the invention.

The term “computer readable medium” or “computer usable medium” as used herein refers to any medium that participates in providing instructions to processor 1407 for execution. Such a medium may take many forms, including but not limited to, non-volatile media and volatile media. Non-volatile media includes, for example, optical or magnetic disks, such as disk drive 1410. Volatile media includes dynamic memory, such as system memory 1408.

Common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 1400. According to other embodiments of the invention, two or more computer systems 1400 coupled by communication link 1410 (e.g., LAN, PTSN, or wireless network) may perform the sequence of instructions required to practice the invention in coordination with one another.

Computer system 1400 may transmit and receive messages, data, and instructions, including program, i.e., application code, through communication link 1415 and communication interface 1414. Received program code may be executed by processor 1407 as it is received, and/or stored in disk drive 1410, or other non-volatile storage for later execution. A database 1432 in a storage medium 1431 may be used to store data accessible by the system 1400.

The techniques described may be implemented using various processing systems, such as clustered computing systems, distributed systems, and cloud computing systems. In some embodiments, some or all of the data processing system described above may be part of a cloud computing system. Cloud computing systems may implement cloud computing services, including cloud communication, cloud storage, and cloud processing.

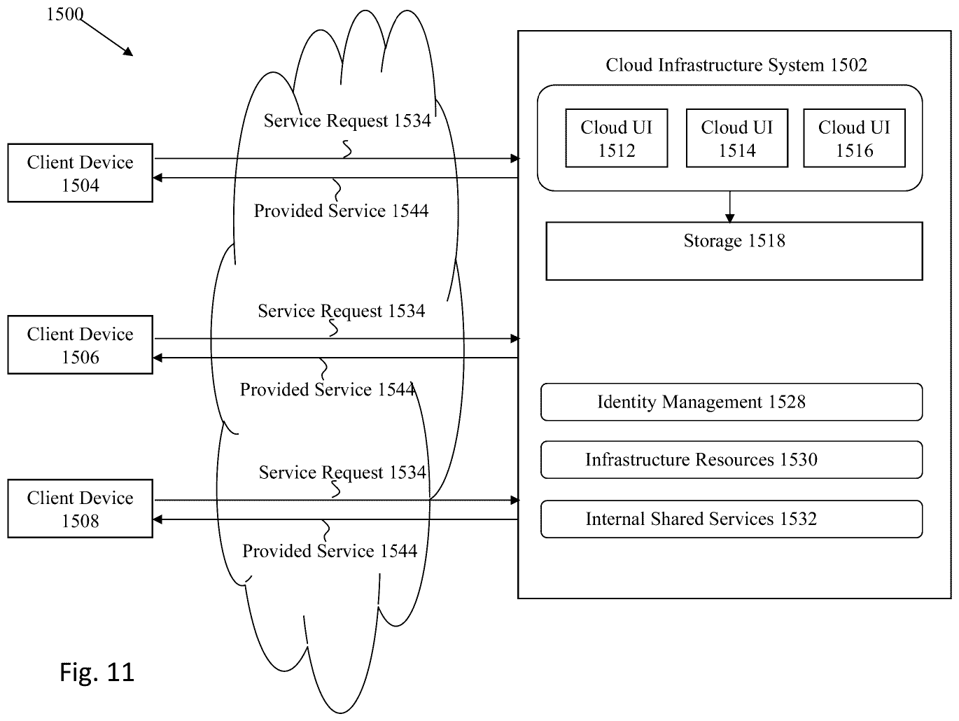

FIG. 11 is a simplified block diagram of one or more components of a system environment 1500 by which services provided by one or more components of an embodiment system may be offered as cloud services, in accordance with an embodiment of the present disclosure. In the illustrated embodiment, system environment 1500 includes one or more client computing devices 1504, 1506, and 1508 that may be used by users to interact with a cloud infrastructure system 1502 that provides cloud services. The client computing devices may be configured to operate a client application such as a web browser, a proprietary client application, or some other application, which may be used by a user of the client computing device to interact with cloud infrastructure system 1502 to use services provided by cloud infrastructure system 1502.

It should be appreciated that cloud infrastructure system 1502 depicted in the figure may have other components than those depicted. Further, the embodiment shown in the figure is only one example of a cloud infrastructure system that may incorporate an embodiment of the invention. In some other embodiments, cloud infrastructure system 1502 may have more or fewer components than shown in the figure, may combine two or more components, or may have a different configuration or arrangement of components. Client computing devices 1504, 1506, and 1508 may be devices similar to those described above for FIG. 14. Although system environment 1500 is shown with three client computing devices, any number of client computing devices may be supported. Other devices such as devices with sensors, etc. may interact with cloud infrastructure system 1502.

Network(s) 1510 may facilitate communications and exchange of data between clients 1504, 1506, and 1508 and cloud infrastructure system 1502. Each network may be any type of network familiar to those skilled in the art that can support data communications using any of a variety of commercially-available protocols. Cloud infrastructure system 1502 may comprise one or more computers and/or servers.

In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the user's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user, or as otherwise known in the art. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 1502 may include a suite of applications, middleware, and database service offerings that are delivered to a user in a self-service, subscription-based, elastically scalable, reliable, highly available, and secure manner.

In various embodiments, cloud infrastructure system 1502 may be adapted to automatically provision, manage and track a user's subscription to services offered by cloud infrastructure system 1502. Cloud infrastructure system 1502 may provide the cloud services via different deployment models. For example, services may be provided under a public cloud model in which cloud infrastructure system 1502 is owned by an organization selling cloud services and the services are made available to the general public or different industry enterprises. As another example, services may be provided under a private cloud model in which cloud infrastructure system 1502 is operated solely for a single organization and may provide services for one or more entities within the organization. The cloud services may also be provided under a community cloud model in which cloud infrastructure system 1502 and the services provided by cloud infrastructure system 1502 are shared by several organizations in a related community. The cloud services may also be provided under a hybrid cloud model, which is a combination of two or more different models.

In some embodiments, the services provided by cloud infrastructure system 1502 may include one or more services provided under Software as a Service (SaaS) category, Platform as a Service (PaaS) category, Infrastructure as a Service (IaaS) category, or other categories of services including hybrid services. A user, via a subscription order, may order one or more services provided by cloud infrastructure system 1502. Cloud infrastructure system 1502 then performs processing to provide the services in the user's subscription order.

In some embodiments, the services provided by cloud infrastructure system 1502 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, users can utilize applications executing on the cloud infrastructure system. Users can acquire the application services without the need for users to purchase separate licenses and support. Various different SaaS services may be provided. Examples include, without limitation, services that provide solutions for sales performance management, enterprise integration, and business flexibility for large organizations.

In some embodiments, platform services may be provided by the cloud infrastructure system via a PaaS platform. The PaaS platform may be configured to provide cloud services that fall under the PaaS category. Examples of platform services may include without limitation services that enable organizations to consolidate existing applications on a shared, common architecture, as well as the ability to build new applications that leverage the shared services provided by the platform. The PaaS platform may manage and control the underlying software and infrastructure for providing the PaaS services. Users can acquire the PaaS services provided by the cloud infrastructure system without the need for users to purchase separate licenses and support.

By utilizing the services provided by the PaaS platform, users can employ programming languages and tools supported by the cloud infrastructure system and also control the deployed services. In some embodiments, platform services provided by the cloud infrastructure system may include database cloud services, middleware cloud services, and Java cloud services. In one embodiment, database cloud services may support shared service deployment models that enable organizations to pool database resources and offer users a Database as a Service in the form of a database cloud. Middleware cloud services may provide a platform for users to develop and deploy various business applications, and Java cloud services may provide a platform for users to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for users utilizing services provided by the SaaS platform and the PaaS platform.

In certain embodiments, cloud infrastructure system 1502 may also include infrastructure resources 1530 for providing the resources used to provide various services to users of the cloud infrastructure system. In one embodiment, infrastructure resources 1530 may include pre-integrated and optimized combinations of hardware, such as servers, storage, and networking resources to execute the services provided by the PaaS platform and the SaaS platform.

In some embodiments, resources in cloud infrastructure system 1502 may be shared by multiple users and dynamically re-allocated per demand. Additionally, resources may be allocated to users in different time zones. For example, cloud infrastructure system 1502 may enable a first set of users in a first time zone to utilize resources of the cloud infrastructure system for a specified number of hours and then enable the re-allocation of the same resources to another set of users located in a different time zone, thereby maximizing the utilization of resources.

In certain embodiments, a number of internal shared services 1532 may be provided that are shared by different components or modules of cloud infrastructure system 1502 and by the services provided by cloud infrastructure system 1502. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

In certain embodiments, cloud infrastructure system 1502 may provide comprehensive management of cloud services (e.g., SaaS, PaaS, and IaaS services) in the cloud infrastructure system. In one embodiment, cloud management functionality may include capabilities for provisioning, managing and tracking a user's subscription received by cloud infrastructure system 1502, and the like.

In one embodiment, as depicted in the figure, cloud management functionality may be provided by one or more modules, such as a storage module 1518. These modules may include or be provided using one or more computers and/or servers, which may be general purpose computers, specialized server computers, server farms, server clusters, or any other appropriate arrangement and/or combination.

In operation 1534, a user using a client device, such as client device 1504, 1506 or 1508, may interact with cloud infrastructure system 1502 by requesting one or more services provided by cloud infrastructure system 1502 and placing an order for a subscription for one or more services offered by cloud infrastructure system 1502. In certain embodiments, the user may access a cloud User Interface (UI), cloud UI 1512, cloud UI 1514 and/or cloud UI 1516 and place a subscription order via these UIs. The order information received by cloud infrastructure system 1502 in response to the user placing an order may include information identifying the user and one or more services offered by the cloud infrastructure system 1502 that the user intends to subscribe to.

In certain embodiments, cloud infrastructure system 1502 may include an identity management module 1528. Identity management module 1528 may be configured to provide identity services, such as access management and authorization services in cloud infrastructure system 1502. In some embodiments, identity management module 1528 may control information about users who wish to utilize the services provided by cloud infrastructure system 1502. Such information can include information that authenticates the identities of such users and information that describes which actions those users are authorized to perform relative to various system resources (e.g., files, directories, applications, communication ports, memory segments, etc.) Identity management module 1528 may also include the management of descriptive information about each user and about how and by whom that descriptive information can be accessed and modified.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

1. An apparatus for executing a workload on a remote server while preserving the appearance of local execution at a client machine, the apparatus comprising:
a client-side component configured to intercept workload execution commands;
a secure network tunnel connecting the client-side component to a remote server;
a resource shim deployed on the client machine and configured to proxy interactions between the workload and operating system resources;
a remote execution engine configured to execute the workload on the remote server;
wherein the workload executes on the remote server, accesses client-side resources through the resource shim, and appears to the client and external systems as if the workload is running locally on the client machine.

2. The apparatus of claim 1, wherein the remote execution engine is further configured to access one or more graphics processing units (GPUs) at the remote server for performing computational operations of the workload.

3. The apparatus of claim 1, further comprising a caching subsystem at the remote server configured to maintain local copies of files accessed from the client machine, wherein the caching subsystem selectively serves workload file requests from either the local cache or the client machine based on a replacement map.

4. The apparatus of claim 3, wherein the replacement map comprises mappings between original client file paths and replacement file paths on the remote server, and wherein the replacement map is dynamically updated during workload execution.

5. The apparatus of claim 1, further comprising a mutable environment engine configured to apply environment-specific patches to files accessed by the workload at the remote server, thereby allowing the workload to execute on hardware or GPU architectures different from those of the client machine.

6. The apparatus of claim 1, further comprising executable code configured to:
evaluate workload resource requirements;
query available remote servers and GPUs for suitability;
select an optimal remote server and GPU for executing the workload based on performance, utilization, and other telemetry data.

7. The apparatus of claim 1, wherein the client-side component is installed within a container image, and the workload is containerized.

8. The apparatus of claim 1, further comprising a privacy-aware file access system configured to determine whether files accessed by the workload are permitted to be cached on the remote server based on user-defined preferences.

9. The apparatus of claim 1, wherein the workload comprises multiple interrelated processes, and wherein inter-process communication between processes is proxied through the resource shim and secure network tunnel to maintain the appearance of local execution.

10. The apparatus of claim 1, further comprising a telemetry collection module configured to gather execution metrics from both the client machine and remote server, wherein the telemetry is used for matchmaking, performance optimization, and resource allocation.

11. The apparatus of claim 1, wherein the secure network tunnel is implemented using a TUN/TAP virtual interface, and wherein routing tables on the remote server are modified to direct workload-generated network traffic through the tunnel.

12. A method for executing a workload remotely while appearing to execute locally at a client machine, the method comprising:
intercepting a command to execute the workload at the client machine;
transmitting the workload to a remote server via a secure network tunnel;
executing the workload on the remote server;
proxying interactions with client-side operating system resources through a shim component;
providing, to the client and external systems, the appearance that the workload is executing locally on the client machine.

13. The method of claim 12, further comprising:
maintaining a replacement map associating file paths on the client machine with replacement paths on the remote server;
selectively serving workload file requests from either the client machine or the remote server based on the replacement map.

14. The method of claim 12, further comprising applying environment-specific patches to files accessed by the workload to enable execution on hardware or GPU architectures different from those of the client machine.

15. The method of claim 12, further comprising evaluating multiple remote GPU servers and selecting an optimal server for workload execution based on workload requirements and real-time telemetry.

16. The method of claim 12, wherein the workload is executed on a remote GPU server while the client resides on a different cloud provider, thereby enabling cross-cloud GPU arbitrage.

17. The method of claim 12, further comprising offloading computationally intensive tasks from an edge device to a remote server, while maintaining the workload execution appearance on the edge device.

18. The method of claim 12, further comprising prefetching or speculatively caching files from the client machine to the remote server based on anticipated workload access patterns, to reduce latency in file access.

19. The method of claim 12, wherein the workload execution is containerized or virtualized, and wherein the system dynamically adapts the container or virtual machine environment at the remote server using the replacement map to maintain compatibility with target hardware.

20. A non-transitory computer program product embodied on a computer readable medium, the computer readable medium having stored thereon a sequence of instructions which, when executed by a processor, performs:
intercepting a command to execute the workload at the client machine;
transmitting the workload to a remote server via a secure network tunnel;
executing the workload on the remote server;
proxying interactions with client-side operating system resources through a shim component;
providing, to the client and external systems, the appearance that the workload is executing locally on the client machine.

21. The computer program product of claim 20, further comprising:
maintaining a replacement map associating file paths on the client machine with replacement paths on the remote server;
selectively serving workload file requests from either the client machine or the remote server based on the replacement map.

22. The computer program product of claim 20, further comprising applying environment-specific patches to files accessed by the workload to enable execution on hardware or GPU architectures different from those of the client machine.

23. The computer program product of claim 20, further comprising evaluating multiple remote GPU servers and selecting an optimal server for workload execution based on workload requirements and real-time telemetry.

24. The computer program product of claim 20, wherein the workload is executed on a remote GPU server while the client resides on a different cloud provider, thereby enabling cross-cloud GPU arbitrage.

25. The computer program product of claim 20, further comprising offloading computationally intensive tasks from an edge device to a remote server, while maintaining the workload execution appearance on the edge device.

26. The computer program product of claim 20, further comprising prefetching or speculatively caching files from the client machine to the remote server based on anticipated workload access patterns, to reduce latency in file access.

27. The computer program product of claim 20, wherein the workload execution is containerized or virtualized, and wherein the system dynamically adapts the container or virtual machine environment at the remote server using the replacement map to maintain compatibility with target hardware.
